(19) United States
(12) Patent Application Publication
(10) Pub. No.: US 2026/0007502 A1
(43) Pub. Date: Jan. 8, 2026

(54) SINGLE FINGER CAP CLEANING FABRIC WITH DENTAL FLOSS

(71) Applicant: OIMO INDUSTRIAL COMPANY LTD., Taipei City (TW)

(72) Inventor: Pai-Yung LIN, Taipei City (TW)

(21) Appl. No.: 18/765,515

(22) Filed: Jul. 8, 2024

(51) Int. Cl. A61C 15/04

(52) U.S. Cl. CPC A61C 15/046

(57) ABSTRACT

A single finger cap cleaning fabric with dental floss, which includes: a first contact fabric piece, a second contact fabric piece, floss, a plurality of joining hot melt threads, and a plurality of fixing hot melt threads. The users can insert their index finger inside a finger cap space formed between the first contact fabric piece and the second contact fabric piece, and then use their thumb to concurrently hold the first and the second long sides of the first and the second contact fabric pieces, thereby enabling using their index finger to move the first and the second contact fabric pieces to carry out the objective of cleaning their teeth, opening up the first and the second long sides of the first and the second contact fabric pieces to reveal the floss inside, and detaching one end of the floss enables cleaning the teeth therewith.

### BACKGROUND OF THE INVENTION

### Field of the Invention

The present invention relates to a single finger cap cleaning fabric with dental floss, and more particularly to a cleaning fabric structure for use in cleaning teeth.

### Description of the Prior Art

General oral care is mainly directed towards cleaning the teeth and tongue, whereby only by removing residual food particles and foreign matter can a person maintain oral health. Currently, the most commonly used cleaning tool is the toothbrush, the main function of which involves first applying toothpaste to the brush portion thereof to proceed with cleaning the teeth. However, apart from the relative inconvenience of having to carry the toothbrush with you, toothpaste must also be used together with the toothbrush, and thus lacks convenience in use. Therefore, toothpicks and dental floss are more convenient options, wherein the end tip of the toothpick and the thread of the dental floss are mainly used to clean between the teeth. However, the toothpick and dental floss can only remove residual food particles and foreign matter remaining between the teeth. and cannot clean the surface of the teeth and tongue. Hence, the inventor of the present invention proposes to resolve and surmount existent technical difficulties to eliminate the aforementioned shortcomings of the prior art.

### SUMMARY OF THE INVENTION

The main object of the present invention lies in assembling a single finger cap cleaning fabric with dental floss from a first contact fabric piece, a second contact fabric piece, floss, a plurality of joining hot melt threads, and a plurality of fixing hot melt threads; wherein the main function of the present invention involves the user inserting their index finger inside a finger cap space formed between the first contact fabric piece and the second contact fabric piece, and then using their thumb to concurrently hold the first long side of the first contact fabric piece and the second long side of the second contact fabric piece, thereby enabling the index finger to be used to move the first contact fabric piece and the second contact fabric piece to carry out the objective of cleaning their teeth. In addition, the finger cap enables opening up the first long side of the first contact fabric piece and the second long side of the second contact fabric piece to reveal the floss inside, and detaching one end of the floss enables cleaning the teeth therewith.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a three-dimensional external view of the present invention.

FIG. 2 is a three-dimensional exploded view of the present invention.

FIG. 3 is a perspective view of the present invention.

FIG. 4 is a first schematic view of a preferred embodiment of the present invention in use.

FIG. 5 is a second schematic view of the preferred embodiment of the present invention in use.

FIG. 6 is a third schematic view of the preferred embodiment of the present invention in use.

FIG. 7 is fourth schematic view of the preferred embodiment of the present invention in use.

### DETAILED DESCRIPTION OF THE PREFERRED EMBODIMENTS

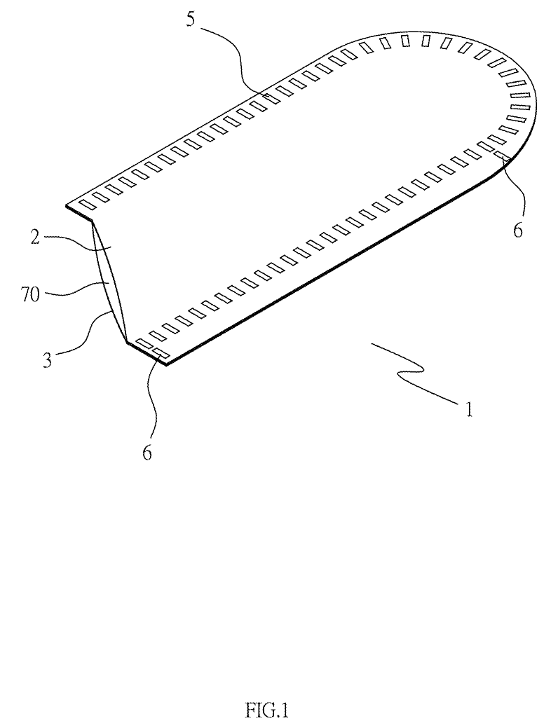

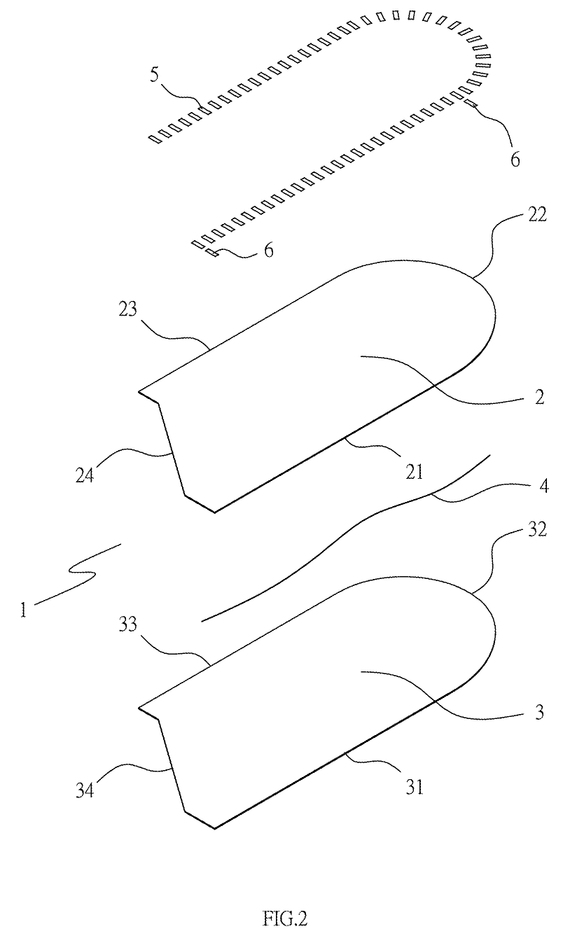

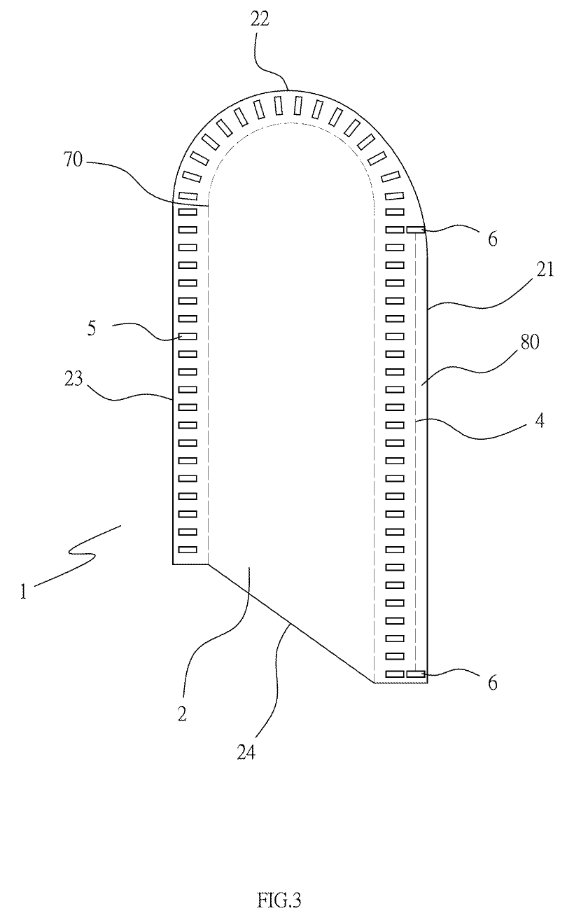

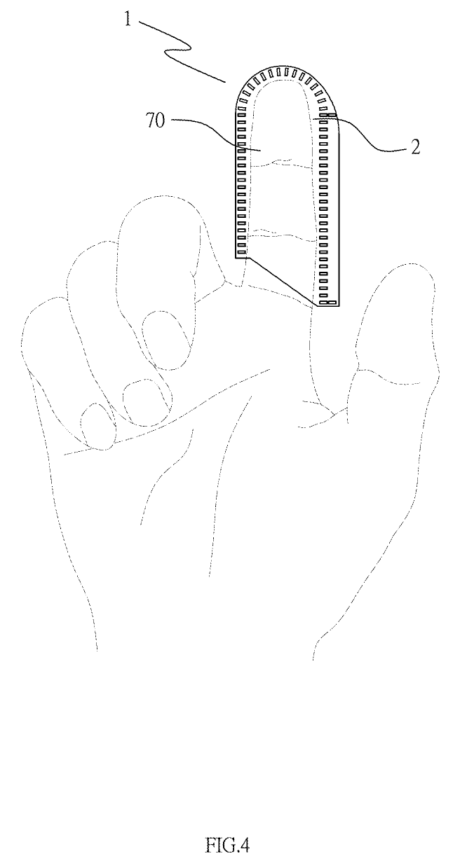

Referring to FIGS. 1, 2, 3, 4, 5, 6, and 7, which show a three-dimensional external view, a three-dimensional exploded view, a perspective view, and schematic views of the present invention; and it can be clearly seen from the drawings that a single finger cap cleaning fabric with dental floss 1 of the present invention mainly comprises:

a first contact fabric piece 2, provided with a first long side 21, a first curved side 22, a first short side 23, and a first slanting side 24;

a second contact fabric piece 3, configured on one side of the first contact fabric piece 2, and provided with a second long side 31, a second curved side 32, a second short side 33, and a second slanting side 34;

floss 4, configured between the first long side 21 of the first contact fabric piece 2 and the second long side 31 of the second contact fabric piece 3;

a plurality of joining hot melt threads 5, configured on the first long side 21, the first curved side 22, and the first short side 23, which are used to join the first contact fabric piece 2 and the second contact fabric piece 3, thereby forming a finger cap space 70 therebetween; and

a plurality of fixing hot melt threads 6, configured on the two ends of the first long side 21 of the first contact fabric piece 2, which are used to fix the two ends of the floss 4, and enables forming a holding space 80 between the first long side 21 of the first contact fabric piece 2 and the second long side 31 of the second contact fabric piece 3.

The dimensions and shape of the first contact fabric piece 2 and the second contact fabric piece 3 are the same.

The second long side 31, the second curved side 32, the second short side 33, and the second slanting side 34 of the second contact fabric piece 3 are correspondingly configured relative to the first long side 21, the first curved side 22, the first short side 23, and the first slanting side 24 of the first contact fabric piece 2.

The plurality of joining hot melt threads 5 are distributed in an equidistant configuration.

Using the single finger cap cleaning fabric with dental floss 1 of the present invention mainly involves the user inserting their index finger inside a finger cap space 70 between the first contact fabric piece 2 and the second contact fabric piece 3, and then concurrently pressing the first long side 21 of the first contact fabric piece 2 and the second long side 31 of the second contact fabric piece 3 with their thumb, thereby enabling the index finger to move the first contact fabric piece 2 or the second contact fabric piece 3 to proceed with cleaning the surfaces of the teeth or tongue.

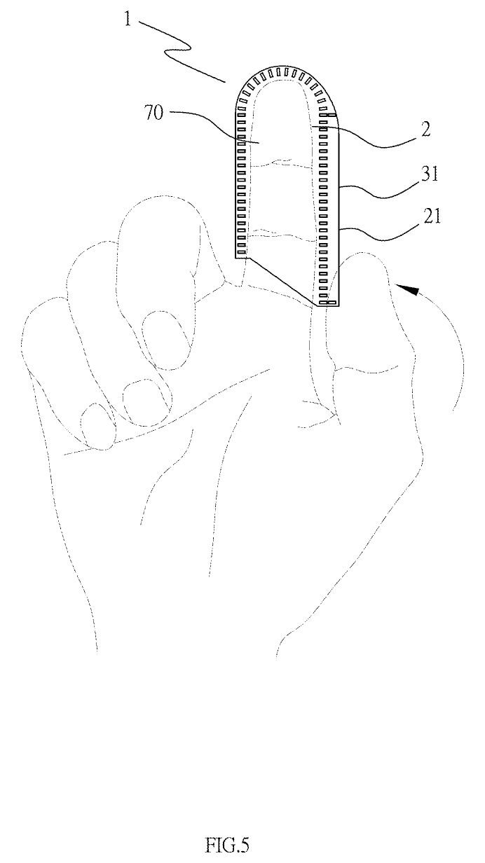

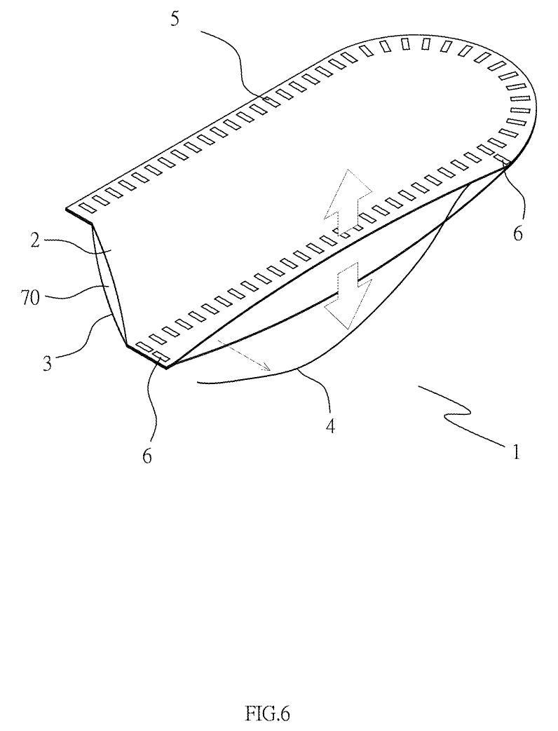

Following the above, referring to FIGS. 5 and 6, after using the first contact fabric piece 2 or the second contact fabric piece 3 to clean the teeth, the thumb can be used to open the first long side 21 of the first contact fabric piece 2 and the second long side 31 of the second contact fabric piece 3 to expose the floss 4 therein and enable detaching one end of the floss 4; the other end remaining fixed by the other fixing hot melt thread 6. The user is then able to hold the detached end of the floss 4 to proceed with cleaning the teeth.

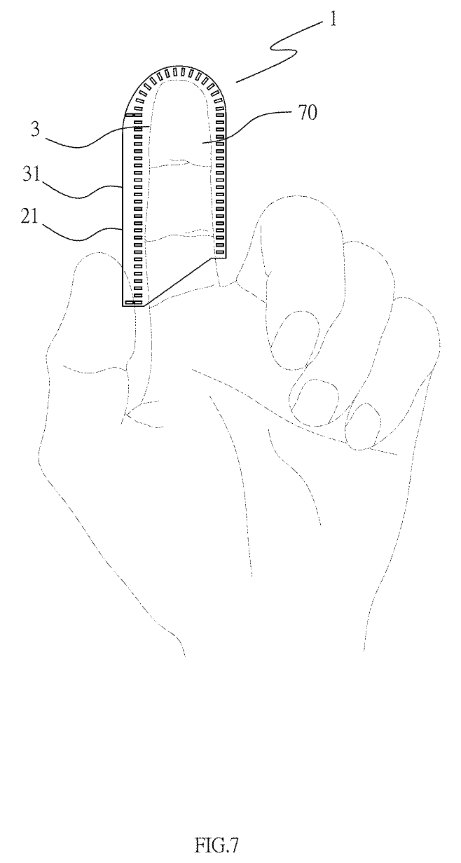

In addition, because the first contact fabric piece 2 and the second contact fabric piece 3 are both able to achieve the object of cleaning the teeth, FIG. 5 shows the index finger of the right hand of a user, and mainly uses the first contact fabric piece 2 to carry out cleaning of the teeth; whereas FIG. 7 shows the index finger of the left hand of a user to enable using the second contact fabric piece 3 to carry out cleaning of the teeth. However, regardless of whether the index finger of the right hand or the left hand is used, the corresponding thumb of the right hand or the left hand can be used to press the first long side 21 of the first contact fabric piece 2 and the second long side 31 of the second contact fabric piece 3.

In conclusion, compared to the shortcomings and inconvenience of toothpicks and dental floss the prior art, the design of the first contact fabric piece 2, the second contact fabric piece 3, the floss 4, the plurality of joining hot melt threads 5, and the plurality of fixing hot melt threads 6 of the present invention enables the user to use their index finger and thumb to quickly carry out cleaning the surfaces of the teeth and tongue. Moreover, the design of the floss 4 further enables achieving the object of cleaning between the teeth.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A single finger cap cleaning fabric with dental floss, comprising:
a first contact fabric piece, provided with a first long side, a first curved side, a first short side, and a first slanting side;
a second contact fabric piece, configured on one side of the first contact fabric piece, and provided with a second long side, a second curved side, a second short side, and a second slanting side;
a floss, configured between the long side of the first contact fabric piece and the long side of the second contact fabric piece;
a plurality of joining hot melt threads, configured on the first long side, the first curved side, and the first short side of the first contact fabric piece, which are used to join the first contact fabric piece and the second contact fabric piece, forming a finger cap space therebetween; and
a plurality of fixing hot melt threads, configured on the two ends of the first long side of the first contact fabric piece, which are used to fix the two ends of the floss, and enables forming a holding space between the first long side of the first contact fabric piece and the second long side of the second contact fabric piece.

2. The single finger cap cleaning fabric with dental floss according to claim 1, wherein the dimensions and shape of the first contact fabric piece and the second contact fabric piece are the same.

3. The single finger cap cleaning fabric with dental floss according to claim 1, wherein the second long side, the second curved side, the second short side, and the second slanting side of the second contact fabric piece are correspondingly configured relative to the first long side, the first curved side, the first short side, and the first slanting side of the first contact fabric piece.

4. The single finger cap cleaning fabric with dental floss according to claim 1, wherein the plurality of joining hot melt threads are distributed in an equidistant configuration.
